(19) United States
(12) Patent Application Publication
(10) Pub. No.: US 2018/0066863 A1
(43) Pub. Date: Mar. 8, 2018

(54) IDENTIFICATION-BASED AUTOMATION

(71) Applicant: Vivint, Inc., Provo, UT (US)

(72) Inventors: Brandon Gordon Hatch, Provo, UT (US); Kendyl Bell, Highland, UT (US)

(21) Appl. No.: 15/258,473

(22) Filed: Sep. 7, 2016

(51) Int. Cl. F24F 11/00; H04W 4/02; H04W 76/02; H04W 48/16; H04W 48/14

(52) U.S. Cl. CPC F24F 11/0012; H04W 4/02; H04W 76/021; G05B 2219/2614; H04W 48/14; F24F 11/006; F24F 11/0086; H04W 48/16

(57) ABSTRACT

A method for an automation system is described. In one embodiment, the method includes identifying a unique beacon identifier from at least one beacon located relative to one or more areas of a premises, determining a location of a first user relative to the one or more areas, querying first user automation preferences relative to the determined location, and initiating a modification of the automation system based at least in part on the first user automation preferences. The first user automation preferences is associated with the first user.

### BACKGROUND

The present disclosure, for example, relates to an automation system, and more particularly to automation control of certain characteristics such as climate, lighting, media, etc., of a premises.

Security and automation systems are widely deployed to provide various types of communication and functional features such as monitoring, communication, notification, and/or others. These systems may be capable of supporting communication with a user through a communication connection or a system management action.

Current premises-related systems such as heating ventilation air conditioning (HVAC) systems are set-and-forget devices. A user sets a temperature for a thermostat that turns the HVAC system on and off based on a currently detected temperature. Occupants of a premises, however, may have differing preferences for a temperature (and/or other conditions) in the premises and/or different regards to costs associated with temperature (and/or other conditions). The current HVAC systems, however, are not configured to cater to one or more preferences of an occupant of the premises, much less multiple occupants of the premises.

### SUMMARY

The present disclosure provides descriptions of systems and methods configured to provide identification-based automation. A premises, such as a home, office, school, etc., may include one or more beacons. The one or more beacons may transmit and/or broadcast a unique identifier. Computing devices such as control panels, tablets, smart phones, laptops, wearable computing device such as a smart watch, etc., may interact with the one or more beacons, which may lead the devices, the beacons, and/or other devices to identify a unique identifier associated with the one or more beacons and determine a location within the premises. In addition, the user's location may be determined by one or more sensors (e.g., sensor units) included as part of a system. For example, a user's location may be determined by facial recognition based at least in part on past and/or present image and/or video data relating to a camera.

In addition, the user's location may be determined by one or more sensors based on the user's proximity and/or a progressive proximity to one or more areas of the home. For example, a user's location may be determined based on triggering one or more proximity sensors that may be associated with a certain area and/or room a premises. As another example, one or more proximity sensors (potentially in combination with other premises-related sensors) may determine a user's location as the user moves into an area and/or from one area to another. Using a smart phone as an example, a first beacon may be located in a family room, a second beacon in a kitchen, etc., and the heating ventilation air conditioning (HVAC) system of the premises may be configured with zones that include the kitchen as one zone and the family room as another zone. The unique identifier of the first beacon may be associated with the family room and the unique identifier of the second beacon may be associated with the kitchen. Accordingly, when an occupant enters the kitchen with a smart phone, the smart phone and/or control panel may receive the unique identifier of the second beacon. The smart phone may perform a query using the unique identifier of the second beacon to determine that the smart phone is located in the kitchen. In some cases, the smart phone may receive the identifier, perform a query using a network and determine its location based at least in part on the query. In some cases, the smart phone query a control panel located at the premises.

In other cases, the control panel may receive the unique identifier directly from the beacon and/or indirectly through the smart phone and may query a local database, a remote server, a cloud server, etc., to determine one or more locations associated with the unique identifier. In some cases, the beacon may be programmed with its location. Thus, in some embodiments, the beacon may transmit its location to the smart phone and/or the control panel in addition to or as an alternative to transmitting the unique identifier.

In some embodiments, the smart phone and/or the control panel may include an application to identify a unique identifier from a beacon, identify an area of the premises associated with the unique identifier, and/or send a request to a control panel to implement user preferences or implement associated with the smart phone. For example, the occupant of the premises carrying the smart phone may create user preferences for an automation system including HVAC settings, lighting settings, media settings (e.g., music, television, etc.), appliance settings, door lock settings, security settings, security camera settings, etc. The user preferences may be stored locally on the smart phone, in a database or storage device located at the premises, on a storage device of a remote server, and/or on a cloud storage device.

In some cases, the smart phone may receive the unique identifier and send information to a control panel. The information may identify the smart phone and include at least the unique identifier of the beacon. The control panel may determine any user preferences associated with the smart phone and implement the user preferences based on the location of the smart phone, which may be determined from the unique identifier of the beacon. In some cases, the smart phone may determine a signal strength between the smart phone and the beacon. Based on the signal strength, the smart phone may approximate its location within the premises. In some cases, the smart phone may receive the unique identifiers from the first and the second beacons and determine the signal strength from each beacon.

Based at least in part on the comparison of the signal strengths, the smart phone may determine its location within the premises. In some cases, the smart phone may transmit the unique identifier and/or signal strength information to a control panel and/or remote computing device or server where the location of the smart phone may be determined. Accordingly, the present disclosure describes systems and methods configured to provide identification-based automation via one or more beacons located in specified areas of a premises, a computing device identifying unique identifiers transmitted by the one or more beacons, determining a location of the computing device based on the one or more identified unique identifiers, and based on the determined location of the computing device implementing user preferences associated with the computing device in relation to an automation system of the premises.

A method for an automation system is described. In one embodiment, the method may include identifying a unique beacon identifier from at least one beacon located relative to one or more areas of a premises, determining a location of a first user relative to the one or more areas, querying first user automation preferences relative to the determined location, and initiating a modification of the automation system based at least in part on the first user automation preferences. The first user automation preferences may be associated with the first user.

In some embodiments, the method may include determining a temperature of the determined location. The location may be determined based on a signal strength between a mobile device and at least one beacon. In some cases, the method may include determining a temperature relative to the premises. The method may include analyzing the first user automation preferences relative to the temperature of the determined location and calculating a first target temperature based at least in part on the analyzing of the first user automation preferences. In some cases, the first target temperature may be modified based at least in part on determining a temperature relative to the premises.

In some embodiments, the method may include identifying a second user within a predetermined range of the first user and calculating a second target temperature based on second user automation preferences associated with the second user. Initiating the modification may include transmitting an instruction to implement the first target temperature based at least in part on a determination relating to the first target temperature and the second target temperature. The determination may be based at least in part on a cost. The determination may be based at least in part on a priority setting. The priority setting may specify that the first user automation preferences supersede the second user automation preferences. The method may include initiating a modification of a climate configuration based at least in part on the determining the location of a first mobile device relative to the one or more areas.

An apparatus for an automation system is also described. The apparatus may include a processor, memory in electronic communication with the processor, and instructions stored in the memory. The instructions may be executable by the processor to identify a unique beacon identifier from at least one beacon located relative to one or more areas of a premises, determine a location of a first user relative to the one or more areas, query first user automation preferences relative to the determined location, and initiate a modification of the automation system based at least in part on the first user automation preferences. The first user automation preferences may be associated with the first user.

A non-transitory computer-readable medium storing computer-executable code for an automation system is also described. The code may be executable by a processor to identify a unique beacon identifier from at least one beacon located relative to one or more areas of a premises, determine a location of a first user relative to the one or more areas, query first user automation preferences relative to the determined location, and initiate a modification of the automation system based at least in part on the first user automation preferences. The first user automation preferences may be associated with the first user.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein—including their organization and method of operation—together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components—including those having a dash and a second reference label—apply to other similar components. If only the first reference label is used in the specification, the description is applicable to any one of the similar components having the same first reference label irrespective of the second reference label.

FIG. 1A shows a block diagram relating to a security and/or an automation system, in accordance with various aspects of this disclosure;

FIG. 1B is a block diagram of an example of a security and/or automation system in accordance with various embodiments;

FIG. 2 shows a block diagram of a device relating to a security and/or an automation system, in accordance with various aspects of this disclosure;

FIG. 3 shows a block diagram of a device relating to a security and/or an automation system, in accordance with various aspects of this disclosure;

FIG. 4 shows a block diagram relating to a security and/or an automation system, in accordance with various aspects of this disclosure;

FIG. 5 shows a block diagram of an apparatus relating to a security and/or an automation system, in accordance with various aspects of this disclosure;

FIG. 6 is a flow chart illustrating an example of a method relating to a security and/or an automation system, in accordance with various aspects of this disclosure;

FIG. 7 is a flow chart illustrating an example of a method relating to a security and/or an automation system, in accordance with various aspects of this disclosure;

FIG. 8 is a flow chart illustrating an example of a method relating to a security and/or an automation system, in accordance with various aspects of this disclosure.

### DETAILED DESCRIPTION

The following relates generally to improving the efficiency of premises-related systems, such as heating ventilation and air conditioning (HVAC) systems relative to user preferences. The typical HVAC system is composed of a single thermostat located in a central location. This single thermostat controls the heating and cooling of an entire home, office, etc. However, while one occupant may prefer cooler temperatures, another may prefer warmer temperatures. Moreover, different areas of a home or building may experience varying amounts of heating and cooling due to the effects of outdoor weather conditions, insulation, activity within the home, etc.

For example, a south-facing, unshaded room in the summer may experience a higher average room temperature than a south-facing room of the same home that is shaded by a large tree. Likewise, a south-facing room is likely to be warmer due to outdoor conditions than a north-facing room, or a top-level room is likely to be warmer than a lower-level room. Nonetheless, the heating and cooling of a typical home is controlled by a central thermostat with a single temperature setting, resulting in only some of the occupants being served adequately while others are not. Similarly, some rooms of a home may be served adequately by a single temperature configuration while other rooms are not. Accordingly, the systems and methods described herein improve the typical automation system to address these concerns and problems.

One aspect of the present systems and methods and related devices is directed to improving HVAC systems. A user may set the thermostat to turn on cooling when the thermostat registers a high temperature threshold, and set the thermostat to turn on heating when the thermostat registers a low temperature threshold. For example, a user may set the thermostat to trigger the furnace turning on when the thermostat registers 68 degrees Fahrenheit (F) or less. Likewise, a user may set the thermostat to trigger the air conditioning unit when the thermostat registers 72 F or more. The problem with using a single thermostat to control an entire house lies in the disparity between one occupant's ideal room temperature and another occupant's ideal room temperature and/or actual temperatures of different locations of the premises. One occupant may prefer a room to be relatively cool such as 70 F while another prefers the same room to be relatively warm such as 74 F.

In one embodiment, the present systems and methods remedy the problems described above regarding current systems by employing multiple sensors such as occupancy sensors, identity sensors, temperature sensors, etc. Thermometers throughout areas of a home or building and outside the home or building may be used to adjust the related system according to a detected occupancy, occupancy identification, and/or identification of occupant temperature preferences. One or more occupants of a home or building may provide their room temperature preferences for one or more rooms of the home or building. Using the example of a home, the master bedroom, master bathroom, spare bedroom, spare bathroom, family room, kitchen, attic, and basement may each include a thermometer.

For example, each room may include a Z-WAVE® thermometer that communicates a current room temperature to a control panel. Additionally, a thermometer may be located outside the home and may communicate a current outdoor temperature to the control panel. In some cases, a current outdoor temperature may be queried from the Internet. Accordingly, the present systems and methods may adjust the home's HVAC system operation based at least in part on detected occupancy and/or location information, among other things. For example, the system may identify an occupant in the home, locate the occupant within the home, query the occupant's room temperature preferences for the identified location, and adjust the heating or cooling of the identified location based on the queried occupant's room temperature preferences. In some cases, the user preference may be stored on the mobile device, by a sensor, in the cloud, and/or in a storage device associated with an automation control panel. Once the system detects the occupant leaving the identified location (e.g., the room, the premises) and/or another condition, the system may revert to a default setting. In some embodiments, the default setting may include reverting to a default temperature for the identified location, turning off the HVAC system, adjusting one or more conditions related to airflow to the identified location (e.g., adjusting a damper in a duct of the HVAC system), and the like.

In some embodiments, a first target temperature may be calculated based on an analysis of the first user automation preferences relative to current and/or past indoor and/or outdoor temperatures. In some cases, the calculated first target temperature may be modified based on at least one of the current indoor and outdoor temperatures. For example, the current indoor temperature of the location may be 75 F and the temperature preference for the identified location based on an occupancy may be 70 F. Accordingly, the system may implement a target temperature of 70 F. Upon determining the outdoor temperature is 100 F, however, the system may adjust the target temperature to 72 F. On the other hand, upon determining the outdoor temperature is 50 F, then system may maintain the target temperature of 70 F. Upon determining the home is no longer occupied, the system may revert to 75 F.

In some cases, the system may identify a second mobile device within a predetermined range of the first mobile device or within a predetermined range of the identified location. The location of the second mobile device may be determined by signal strength relative to the one or more beacons at the premises. Accordingly, the system may calculate a second target temperature based on second user automation preferences associated with the second mobile device. In some cases, the preferences relative to the first and second mobile devices may conflict. For example, the first user device may be associated with a preference of 70 F while the second user device may be associated with a preference of 75 F. Accordingly, the system may analyze each preference relative to the other, relative to the indoor and outdoor temperatures, relative to energy use, relative to energy prices, and/or other information. In some cases, the system may query the Internet and/or another source for current energy prices. In some cases, the system may store energy ratings for the heating and cooling elements of the HVAC system. Thus, the system may initiate and/or implement the first or the second target temperature or some temperature between the first and second target temperatures based on determinations of energy use, energy costs, and/or indoor and/or outdoor climate conditions (current and/or past). In some cases, the system may implement the first or second target temperature based on a priority configuration where the temperature preferences associated with one mobile device are configured to supersede those of the other mobile device. Benefits may be realized by the abovementioned systems and methods via improved efficiencies relative to the systems such as the HVAC system, improved levels of comfort, and less wasted energy.

The following description provides examples and is not limiting of the scope, applicability, and/or examples set forth in the claims. Changes may be made in the function and/or arrangement of elements discussed without departing from the scope of the disclosure. Various examples may omit, substitute, and/or add various procedures and/or components as appropriate. For instance, the methods described may be performed in an order different from that described, and/or various steps may be added, omitted, and/or combined. Also, features described with respect to some examples may be combined in other examples.

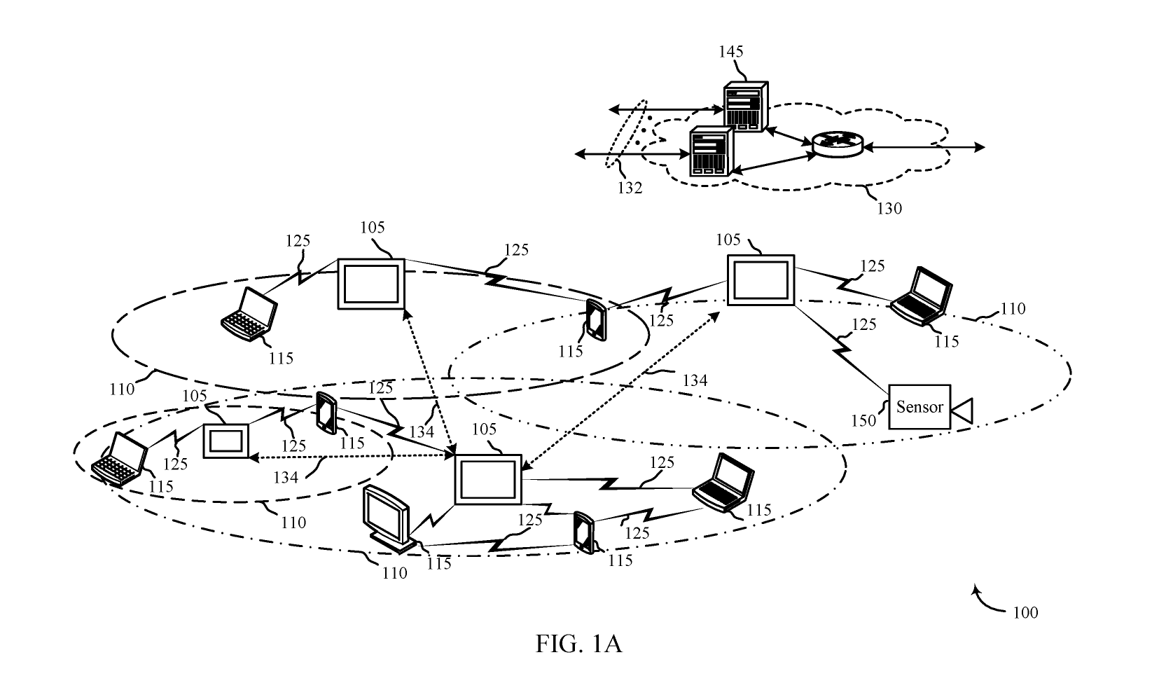

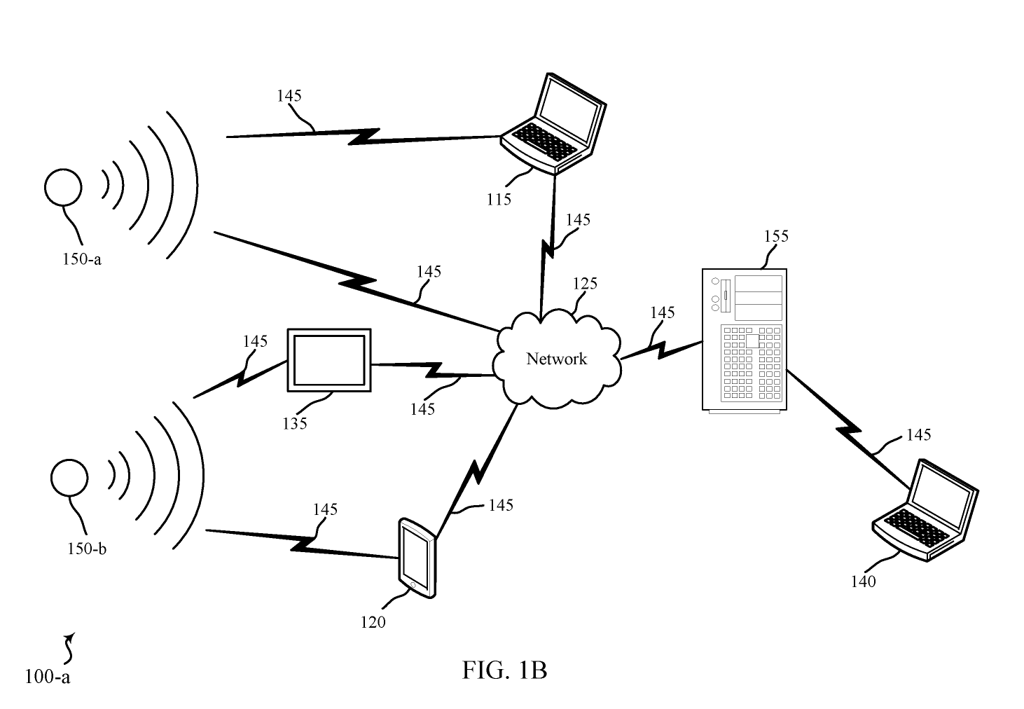

FIG. 1A illustrates an example of a communications system 100 in accordance with various aspects of the disclosure. The communications system 100 may include control panels 105, devices 115, a network 130, and/or sensors 150. The network 130 may provide user authentication, encryption, access authorization, tracking, Internet Protocol (IP) connectivity, and other access, calculation, modification, and/or functions. The control panels 105 may interface with the network 130 through wired and/or wireless communication links 132 to communicate with one or more remote servers 145. The control panels 105 may perform communication configuration, adjustment, and/or scheduling for communication with the devices 115, or may operate under the control of a controller. In various examples, the control panels 105 may communicate—either directly or indirectly (e.g., through network 130)—with each other over wired and/or wireless communication links 134. Control panels 105 may communicate with a back end server (such as the remote servers 145)—directly and/or indirectly—using one or more communication links.

The control panels 105 may wirelessly communicate with the devices 115 via one or more antennas. Each of the control panels 105 may provide communication coverage for a respective geographic coverage area 110. In some examples, control panels 105 may be referred to as a control device, a base transceiver station, a radio base station, an access point, a radio transceiver, or some other suitable terminology. The geographic coverage area 110 for a control panel 105 may be divided into sectors making up only a portion of the coverage area. The communications system 100 may include control panels 105 of different types. There may be overlapping geographic coverage areas 110 for one or more different parameters, including different technologies, features, subscriber preferences, hardware, software, technology, and/or methods. For example, each control panel 105 may be related to one or more discrete structures (e.g., a home, a business) and each of the one more discrete structures may be related to one or more discrete areas. In other examples, multiple control panels 105 may be related to the same one or more discrete structures (e.g., multiple control panels relating to a home and/or a business complex).

The devices 115 may be dispersed throughout the communications system 100 and each device 115 may be stationary or mobile. A device 115 may include a cellular phone, a personal digital assistant (PDA), a wireless modem, a wireless communication device, a handheld device, a tablet computer, a laptop computer, a cordless phone, a wireless local loop (WLL) station, a display device (e.g., TVs, computer monitors, etc.), a printer, a camera, a key fob, and/or the like. A device 115 may also include or be referred to by those skilled in the art as a user device, a smartphone, a BLUETOOTH® device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology.

The sensors 150 may be dispersed throughout the communications system 100 and each sensor 150 may be stationary and/or mobile. A sensor 150 may include and/or be one or more sensors that sense: proximity, motion, temperatures, humidity, sound level, smoke, structural features (e.g., glass breaking, window position, door position), time, light geo-location data of a user and/or a device, distance, biometrics, weight, speed, height, size, preferences, light, darkness, weather, time, system performance, facial recognition, facial features, and/or other inputs that relate to a security and/or an automation system. A device 115 and/or a sensor 150 may be able to communicate through one or more wired and/or wireless connections with various components such as control panels, base stations, and/or network equipment (e.g., servers, wireless communication points, etc.) and/or the like. In some cases, sensor 150 may include one or more sensors of a positioning system. In one embodiment, sensor 150 may include an IBEACON®.

The communication links 125 shown in communications system 100 may include uplink (UL) transmissions from a device 115 to a control panel 105, and/or downlink (DL) transmissions, from a control panel 105 to a device 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies. Each modulated signal may be sent on a different sub-carrier and may carry control information (e.g., reference signals, control channels, etc.), overhead information, user data, etc. The communication links 125 may transmit bidirectional communications and/or unidirectional communications. Communication links 125 may include one or more connections, including but not limited to, 345 MHz, Wi-Fi, BLUETOOTH®, BLUETOOTH® Low Energy, cellular, Z-WAVE®, 802.11, peer-to-peer, LAN, WLAN, Ethernet, fire wire, fiber optic, and/or other connection types related to security and/or automation systems.

In some embodiments, of communications system 100, control panels 105 and/or devices 115 may include one or more antennas for employing antenna diversity schemes to improve communication quality and reliability between control panels 105 and devices 115. Additionally or alternatively, control panels 105 and/or devices 115 may employ multiple-input, multiple-output (MIMO) techniques that may take advantage of multi-path, mesh-type environments to transmit multiple spatial layers carrying the same and/or different coded data.

While the devices 115 may communicate with each other and/or with one or more other sensors 150 through the control panel 105 using communication links 125, each device 115 may also communicate directly with one or more other devices 115 and/or one or more sensors 150 via one or more direct communication links 125. Two or more devices 115 may communicate via a direct communication link 125 when both devices 115 are in the geographic coverage area 110, one devices 115 is in the geographic coverage area 110, and/or when one or neither devices 115 is within the geographic coverage area 110. Examples of direct communication links 125 may include Wi-Fi Direct, BLUETOOTH®, wired, and/or, and other P2P group connections. The devices 115 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, etc. In other implementations, other peer-to-peer connections and/or ad hoc networks may be implemented within communications system 100.

FIG. 1B is an example of a communications system 100-a in accordance with various aspects of the disclosure. Communications system 100-a may be on example of communications system 100 of FIG. 1A. In some embodiments, the communications system 100-a may include one or more sensor units such as 150-a and 150-b, local computing devices 115, 120, network 125, server 155, control panel 135, and/or remote computing device 140. The one or more sensor units 150-a, 150-b may communicate via wired or wireless communication links 145 with one or more of the local computing device 115, 120 and/or network 125. The network 125 may communicate via wired or wireless communication links 145 with the control panel 135 and/or the remote computing device 140 via server 155. In alternate embodiments, the network 125 may be integrated with any one of the local computing devices 115, 120, server 155, and/or remote computing device 140, such that separate components are not required.

Local computing device 115, 120 and remote computing device 140 may be custom computing entities configured to interact with sensor units 150-a, 150-b via network 125, and in some embodiments, via server 155. In other embodiments, local computing device 115, 120 and remote computing device 140 may be general purpose computing entities such as a personal computing device, for example, a desktop computer, a laptop computer, a netbook, a tablet personal computer (PC), a control panel, an indicator panel, a multi-site dashboard, an iPod®, an iPad®, a smart phone, a mobile phone, a personal digital assistant (PDA), and/or any other suitable device operable to send and receive signals, store and retrieve data, and/or execute modules.

Control panel 135 may be a smart home system panel, for example, an interactive panel mounted on a wall in a user's home. Control panel 135 may be in direct communication via wired or wireless communication links 145 with the one or more sensor units 150-a, 150-b, and/or may receive sensor data from the one or more sensor units 150-a, 150-b via local computing devices 115, 120 and/or network 125, and/or may receive data via remote computing device 140, server 155, and/or network 125.

The local computing devices 115, 120 may include memory, a processor, an output, a data input and a communication module. The processor may be a general purpose processor, a Field Programmable Gate Array (FPGA), an Application Specific Integrated Circuit (ASIC), a Digital Signal Processor (DSP), and/or the like. The processor may be configured to retrieve data from and/or write data to the memory. The memory may be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, cloud storage, and/or so forth. In some embodiments, the local computing devices 115, 120 may include one or more hardware-based modules (e.g., DSP, FPGA, ASIC) and/or software-based modules (e.g., a module of computer code stored at the memory and executed at the processor, a set of processor-readable instructions that may be stored at the memory and executed at the processor) associated with executing an application, such as, for example, receiving and displaying data from sensor units 150-a, 150-b.

The processor of the local computing devices 115, 120 may be operable to control operation of the output of the local computing devices 115, 120. The output may be a television, a liquid crystal display (LCD) monitor, a cathode ray tube (CRT) monitor, speaker, tactile output device, and/or the like. In some embodiments, the output may be an integral component of the local computing devices 115, 120. Similarly stated, the output may be directly coupled to the processor. For example, the output may be the integral display of a tablet and/or smart phone. In some embodiments, an output module may include, for example, a High Definition Multimedia Interface™ (HDMI) connector, a Video Graphics Array (VGA) connector, a Universal Serial Bus™ (USB) connector, a tip, ring, sleeve (TRS) connector, and/or any other suitable connector operable to couple the local computing devices 115, 120 to the output.

The remote computing device 140 may be a computing entity operable to enable a remote user to monitor the output of the sensor units 150-a, 150-b. The remote computing device 140 may be functionally and/or structurally similar to the local computing devices 115, 120 and may be operable to receive data streams from and/or send signals to at least one of the sensor units 150-a, 150-b via the network 125. The network 125 may be the Internet, an intranet, a personal area network, a local area network (LAN), a wide area network (WAN), a virtual network, a telecommunications network implemented as a wired network and/or wireless network, etc. The remote computing device 140 may receive and/or send signals over the network 125 via communication links 145 and server 155.

Data gathered by and/or transmitted by the one or more sensor units 150-a, 150-b may be communicated to local computing device 115, 120, which may be, in some embodiments, a thermostat or other wall-mounted input/output smart home display. In other embodiments, local computing device 115, 120 may be a personal computer or smart phone. Where local computing device 115, 120 is a smart phone, the smart phone may have a dedicated application directed to communicating device identification data. The sensor units 150-a, 150-b may process data received from the local computing device 115, 120 to obtain location information. In alternate embodiments, remote computing device 140 and/or control panel 135 may process the data received by the one or more sensor units 150-a, 150-b, via network 125 and server 155, to obtain location information relative to an occupant of a premises. Data transmission may occur via, for example, frequencies appropriate for a personal area network (such as BLUETOOTH®, BLUETOOTH Low Energy (BLE), or IR communications), WiFi, cellular, or local or wide area network frequencies such as radio frequencies specified by the IEEE 802.15.4 standard.

In some embodiments, the one or more sensor units 150-a, 150-b may be sensors configured to conduct periodic and/or ongoing automatic measurements related to device detection. For example, sensor units 150-a, 150-b may be configured to detect a mobile device such as device 120 and/or a control panel 135. Each sensor unit 150-a and/or 150-b may be capable of sensing multiple device parameters, or alternatively, separate sensor units 150-a, 150-b may monitor separate device parameters. For example, one sensor unit 150-a may detect motion, while another sensor unit 150-b (or, in some embodiments, the same sensor unit 150-a) may detect an identifier transmitted by a device (e.g., device 115, 120, and/or 135). In some cases, sensor units 150-a, 150-b may be configured to communicate a globally unique identifier to a device such as device 115, 120, and/or 135. In some embodiments, sensor units 150-a, 150-b may be one example of sensor 150 of FIGS. 1A and/or 1B described above. Thus, in some embodiments, sensor units 150-a, 150-b may include an IBEACON® device and/or may include one or more sensors of a positioning system.

In some embodiments, sensor units 150-a, 150-b may send location information to a control panel, smart phone, and/or other computing device. In one embodiment, control panel 135 may communicate with each of the depicted sensor units 150-a, 150-b regarding location information. In some cases, the control panel 135 may receive location information from one or more sensors 150a, 150-b. In some cases, control panel 135 may send a first set of location information to sensor unit 150-a and send a second set of location information to sensor unit 150-b. As one example, control panel 135 may send data informing sensor unit 150-a that it is located in a “kitchen” of a premises, and control panel 135 may send data informing sensor unit 150-b that it is located in a “family room” of the premises. The HVAC system of the premises may include a zone for the “kitchen” and a zone for the “family room.” Thus, upon detecting a smart phone of an occupant communicating with sensor unit 150-a in the kitchen, the control panel 135 may determine the preferences for that occupant and initiate a modification of and/or adjust the settings of the “kitchen” zone according to the determined preferences. Thus, in some embodiments, sensor units 150-a, 150-b may enable devices to approximate their location within a premises and adjust settings, such as HVAC settings, of the premises according to their approximated location within the premises.

In some embodiments, local computing device 115, 120 may communicate with remote computing device 140 and/or control panel 135 via network 125 and/or server 155. Examples of networks 125 include cloud networks, local area networks (LAN), wide area networks (WAN), virtual private networks (VPN), wireless networks (using 802.11, for example), and/or cellular networks (using 3G and/or LTE, for example), etc. In some configurations, the network 125 may include the Internet. In some embodiments, a user may access the functions of local computing device 115, 120 from remote computing device 140. For example, in some embodiments, remote computing device 140 may include a mobile application that interfaces with one or more functions of local computing device 115, 120.

The server 155 may be configured to communicate with the sensor units 150-a, 150-b, the local computing devices 115, 120, the remote computing device 140, and/or control panel 135. The server 155 may perform additional processing on signals received from the sensor units 150-a, 150-b and/or local computing devices 115, 120, and/or may simply forward the received information to the remote computing device 140 and/or the one or more control panels 135.

Server 155 may be a computing device operable to receive data (e.g., from sensor units 150-a, 150-b and/or local computing device 115, 120 or remote computing device 140), store and/or process data, and/or transmit data and/or data summaries (e.g., to remote computing device 140). For example, server 155 may receive data from a sensor unit 150, data from the same or a different sensor unit 150, data from either the same or yet another sensor unit 150, from local computing devices 115, 120, and/or the control panel 135. In some embodiments, server 155 may “pull” the data, e.g., by querying the sensor units 150-a, 150-b, the local computing devices 115, 120, and/or the control panel 135. In some embodiments, the data may be “pushed” from the sensor units 150-a, 150-b and/or the local computing devices 115, 120 to the server 155. For example, the sensor units 150-a, 150-b and/or the local computing device 115, 120 may be configured to transmit data as it is generated by and/or entered into that device. In some instances, the sensor units 150-a, 150-b and/or the local computing devices 115, 120 may periodically, continuously, and/or otherwise transmit data (e.g., as a block of data or as one or more data points).

The server 155 may include a database (e.g., in memory) containing data received from the sensor units 150-a, 150-b and/or the local computing devices 115, 120. Additionally, as described in further detail herein, software (e.g., stored in memory) may be executed on a processor of the server 155. Such software (executed on the processor) may be operable to cause the server 155 to monitor, process, summarize, present, and/or send a signal associated with resource usage data.

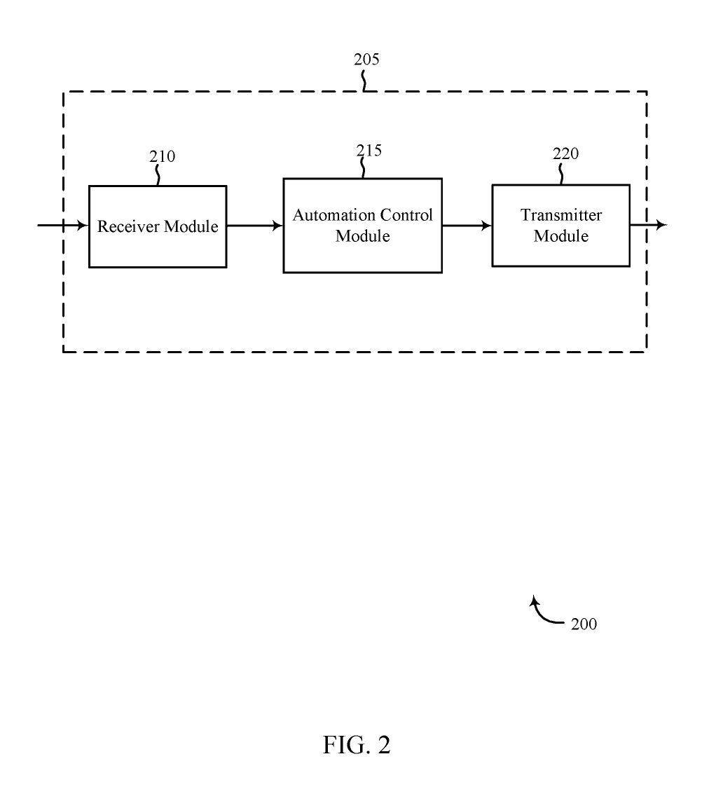

FIG. 2 shows a block diagram 200 of an apparatus 205 for use in electronic communication, in accordance with various aspects of this disclosure. In one embodiment, the apparatus 205 may be an example of one or more aspects of a control panel 105 of FIG. 1A and/or control panel 135 of FIG. 1B. In some embodiments, apparatus 205 may be an example of a computing device such as a mobile device, laptop, desktop, etc., as illustrated by device 115 of FIG. 1A and/or device 115, 120, 130, or 140 of FIG. 1B. In some cases, apparatus 205 may be an example of a beacon in a premises, as illustrated by sensor 150 of FIG. 1A and/or sensor units 150-a, 150-b of FIG. 1B.

The components of the apparatus 205 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The receiver module 210 may receive information such as packets, user data, and/or control information associated with various information channels (e.g., control channels, data channels, etc.). The receiver module 210 may be configured to receive data and/or control information from another device such as a control panel, computing device, sensor, and/or a beacon. Information may be passed on to the automation control module 215, and to other components of the apparatus 205. The data received by receiver module 210 may include data related to device location and identification-based automation control performed by automation control module 215.

In conjunction with one or more beacon devices, one embodiment may include automation control module 215 communicating with a mobile device (e.g., a smart phone, a key fob) related to the occupant to determine the location of the occupant within the premises. Upon determining the location of the occupant within the premises, automation control module 215 may determine whether preferences have been configured for the occupant. Upon identifying the preferences of the occupant, automation control module 215 may initiate a modification of the settings of the system according to the identified preferences. For example, the control panel 135 may send a signal to another device in the automation system and/or a computing device to initiate the modification of the settings of the HVAC system. In some cases, the preferences of the occupant may include settings such as HVAC settings, lighting settings, media settings (e.g., music, video, television, etc.), appliance settings, door lock settings, security camera settings, etc., and automation control module 215 may be configured to adjust these additional settings according to the detected location and/or preferences of the occupant. In some embodiments, a room or HVAC zone of the premises may be configured to enter a dormant state upon determining the room or HVAC zone is unoccupied. Upon determining the room and/or HVAC zone is occupied, the automation control module 215 may identify the occupant and adjust settings of the automation system according to user preferences.

The transmitter module 220 may transmit the one or more signals received from other components of the apparatus 205 and/or the system. The transmitter module 220 may transmit data and/or controls signals to a control panel and/or sensor associated with the security and/or automation system. The data and/or control signals transmitted by the transmitter module 220 may be associated with device location and identification-based automation control performed by automation control module 215. In some examples, the transmitter module 220 may be co-located with the receiver module 210 in a transceiver module.

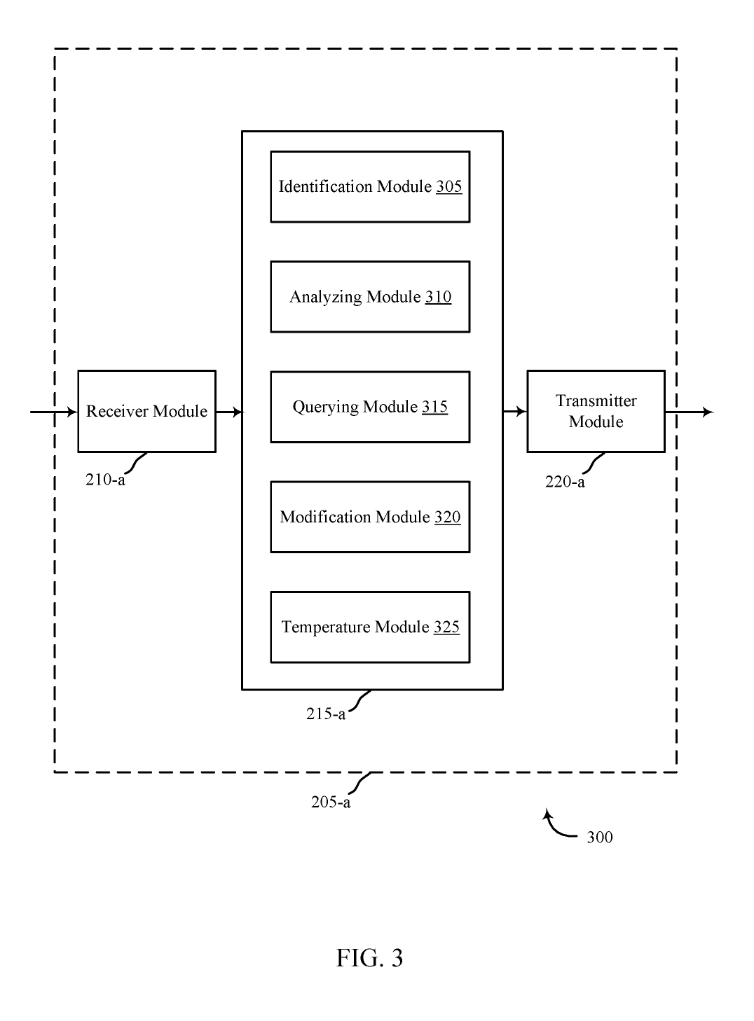

FIG. 3 shows a block diagram 300 of an apparatus 205-a for use in wireless communication, in accordance with various examples. The apparatus 205-a may be an example of one or more aspects of control panel 105 of FIG. 1A or control panel 135 of FIG. 1B. In some embodiments, apparatus 205-a may be an example of a computing device such as a mobile device, laptop, desktop, etc., as illustrated by devices 115 of FIG. 1A and/or devices 115, 120, 130, or 140 of FIG. 1B. It may also be an example of an apparatus 205 described with reference to FIG. 2. In some cases, apparatus 205-a may be an example of a beacon in a premises, as illustrated by sensor 150 of FIG. 1A and/or sensor units 150-a, 150-b of FIG. 1B. The apparatus 205-a may include a receiver module 210-a, an automation control module 215-a, and/or a transmitter module 220-a, which may be examples of the corresponding modules of apparatus 205. The apparatus 205-a may also include a processor. Each of these components may be in communication with each other. The automation control module 215-a may be configured to provide identification-based automation relative to an automation system at a premises.

In some cases, automation control module 215-a may provide certain functions based at least in part on detecting occupancy, movement of one or more users, facial features of one or more users and/or other information related to the premises. For example, upon detecting occupancy at the premises via one or more sensors (e.g., motion detection, detecting an identifier associated with an occupant via a key fob or mobile computing device, detecting occupancy location via global positioning system (GPS), etc.), automation control module 215-a may determine a location of an occupant within the premises. Upon detecting no occupancy in the premises, automation control module 215-a may implement a default configuration, such as a default climate, lighting, media, and/or appliance configuration, among others.

The automation control module 215-a may include identification module 305, analyzing module 310, querying module 315, modification module 320, and temperature module 325. The receiver module 210-a and the transmitter module 220-a may perform the functions of the receiver module 210 and the transmitter module 220, of FIG. 2, respectively. In one embodiment, identification module 305 may be configured to identify a unique beacon identifier from at least one beacon located relative to one or more areas of the premises. In some cases, the beacon may include one or more sensors of an indoor positioning system. In one embodiment, the beacon may include an IBEACON® configured according to an IBEACON® standard set by APPLE®. For example, the beacon may include transmitters that notify nearby devices (e.g., devices 105, 115, 120, 130, 140, and 145 of FIGS. 1A and/or 1B) of their presence and/or location at the premises.

Accordingly, as one example, the beacon may enable a smart phone and/or a control panel to perform actions when the user's smart phone is within a certain proximity to the beacon. In one embodiment, the beacon may enable the smart phone and/or the control panel to determine the smart phone's approximate location and/or context within the premises. In one embodiment, the beacon may enable the smart phone to determine the user's approximate location or context within the premises. The beacon may use low energy proximity sensing to transmit a universally unique identifier that is identified by a compatible application or operating system running on the smart phone.

The reception of the unique identifier by the smart phone may trigger the smart phone and/or the control panel to perform one or more operations such as looking up the unique identifier using one or more communications connections to determine location of the beacon and thereby determine the location of the smart phone. In some cases, the reception of the unique identifier may trigger the smart phone to check-in on social media, to receive data, send data, receive and/or display a push notification, etc. The notification may request a user to make a selection relative to the displayed notification. In some cases, a local database and/or remote or cloud data storage device may be queried in relation to the unique identifier to determine the location of the beacon and/or to determine user preferences associated with the smart phone.

In one embodiment, analyzing module 310 may analyze the location of a user and/or a user's device in relation to a location of a beacon within a premises. The analyzing module 310 may analyze image data (e.g., still image data, video image data) captured of the user and perform facial recognition and/or object recognition (using edges, colors, shapes, sizes, etc.) to determine the identity and/or the location of the user. In some embodiments, analyzing module 310 may be configured to determine a signal strength between a first mobile device and the at least one beacon. Based on the comparison, the analyzing module 310 may determine a location of the first mobile device within the premises based on the determined signal strength. In some cases, analyzing module 310 may compare a signal strength of a first beacon with a signal strength of a second beacon. Based on the comparison, the analyzing module 310 may determine a location of the first mobile device within the premises based on the comparison of the signal strengths.

In one embodiment, querying module 315 may be configured to query first user automation preferences in relation to location information, such as the determined location. The first user automation preferences may be associated with the first mobile device and/or a first user. For example, the user of the first mobile device may specify user preferences for the automation system of the premises that include one or more preferences regarding HVAC settings (e.g., temperature, humidity, airflow, etc.), lighting settings, media settings (e.g., music, television, etc.), appliance settings, door lock settings, security settings, security camera settings, etc.

In some cases, modification module 320 may modify an aspect of the automation system based at least in part on the first user automation preferences for the determined location within the premises. In some embodiments, modification module 320 may modify an aspect of the user preferences and/or one or more settings based on current and/or past internal and/or external conditions associated with the premises. For example, the user preferences may specify a room temperature of 72 degrees Fahrenheit (F) when the current outdoor temperature is 90 F, the current indoor temperature at the determined location is 75 F, and the current energy costs are at a relative high compared to historical prices (e.g., energy prices during the middle of the day may be higher than energy prices at night, etc.). Based on these conditions, modification module 320 may modify the target temperature to 73 F or 74 F. In some cases, the user may be prompted to accept this suggested modification and/or override the suggestion and/or manually set the target temperature.

In one embodiment, temperature module 325 may determine a past indoor temperature of the determined location of the device within the premises and/or determine a current outdoor temperature relative to the premises. Accordingly, analyzing module 310 may analyze the first user automation preferences relative to the indoor temperature of the determined location and/or the outdoor temperature. Analyzing module 310 may calculate a first target temperature based at least in part on the analysis of the first user automation preferences. As described above, modification module 320 may modify the calculated first target temperature based on conditions such as the current and/or the past outdoor temperature, indoor temperature, energy prices, etc.

In one embodiment, identification module 305 may be configured to identify a second mobile device. The second mobile device may be within a predetermined range of the first mobile device, a control panel, and/or a beacon. In some cases, at least one of the control panel, one or more beacons, and/or the first mobile device may communicate with the second mobile device (e.g., via an application on each device). The mobile devices may exchange information regarding communication with the one or more beacons. For example, the mobile devices may share data regarding the respective signal strengths of communications between the mobile devices and/or the one or more beacons. Accordingly, each mobile device may determine the relative position to one another and/or a location within the premises with respect to each other.

In one embodiment, analyzing module 310 may calculate a second target temperature based on the identification module 305 identifying second user automation preferences associated with the second mobile device. In some embodiments, automation control module 215-a may implement the first target temperature based on a determination, by analyzing module 310, that implementing the first target temperature uses less energy than implementing the second target temperature. For example, a database may include energy rating information for at least one component of the automation system such as the energy rating of a furnace and/or air conditioner in the HVAC system. Thus, analyzing module 310 may query the database to obtain the energy rating information and select a target temperature accordingly. Additionally, or alternatively, automation control module 215-a may implement the first target temperature based on a determination, by analyzing module 310, that implementing the first target temperature costs less than implementing the second target temperature. For example, analyzing module 310 may query a database that includes current energy prices. The current energy prices may be based on the time of day, market trends, historical data, user price tolerance, etc.

In some embodiments, a database may include priority settings for occupants of the premises. For instance, the priority setting may specify that the first user automation preferences supersede the second user automation preferences. For example, the user preferences of a parent may be set to supersede the user preferences of a child in a home. The preferences of “mom” may supersede those of anyone else in the home, followed in order by “dad,” “child,” “visitor,” etc. In some cases, the preferences of “visitor” may be set to temporarily supersede those of other occupants. For example, the preferences of a “visitor” may be programmed with an expiration. Upon expiring, the preferences of the visitor may be deleted and/or suspended from the system. Thus, automation control module 215-a may implement the first target temperature based on a priority setting.

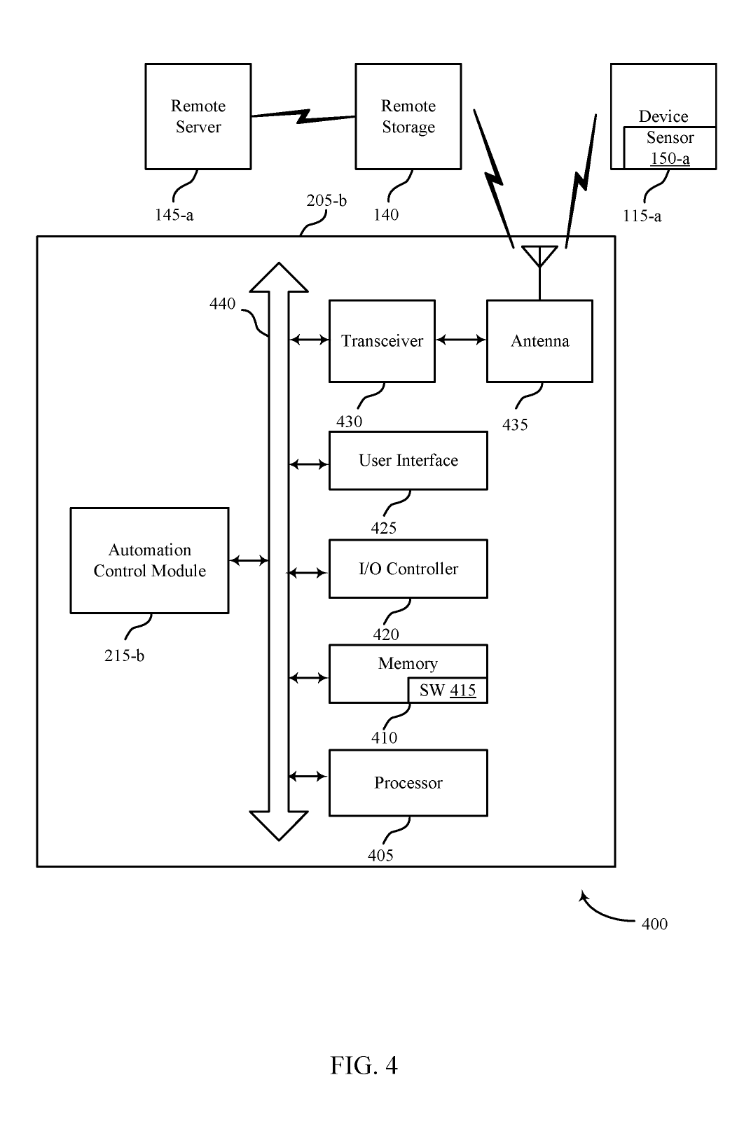

FIG. 4 shows a system 400 for use in automation systems, in accordance with various examples. System 400 may include an apparatus 205-b. The apparatus 205-b may be an example of one or more aspects of control panel 105 of FIG. 1A, control panel 135 of FIG. 1B, and/or control panel 205-a of FIG. 3. In some embodiments, apparatus 205-b may be an example of a computing device such as a mobile device, laptop, desktop, etc., as illustrated by devices 115 of FIG. 1A and/or devices 115, 120, 130, or 140 of FIG. 1B. It may also be an example of an apparatus 205 described with reference to FIG. 2. In some cases, apparatus 205-b may be an example of a beacon in a premises, as illustrated by sensor 150 of FIG. 1A and/or sensor units 150-a, 150-b of FIG. 1B.

Apparatus 205-b may also include components for bi-directional voice and data communications including components for transmitting communications and components for receiving communications. For example, apparatus 205-b may communicate bi-directionally with one or more of device 115-a, one or more sensors 150-a, remote storage 140, and/or remote server 145-a, which may be an example of the remote server of FIGS. 1A and/or 1B. This bi-directional communication may be direct (e.g., apparatus 205-b communicating directly with remote storage 140) or indirect (e.g., apparatus 205-b communicating indirectly with remote server 145-a through remote storage 140).

Apparatus 205-b may also include a processor module 405, and memory 410 (including software/firmware code (SW) 415), an input/output controller module 420, a user interface module 425, a transceiver module 430, and one or more antennas 435 each of which may communicate—directly or indirectly—with one another (e.g., via one or more buses 440). The transceiver module 430 may communicate bi-directionally—via the one or more antennas 435, wired links, and/or wireless links—with one or more networks or remote devices as described above. For example, the transceiver module 430 may communicate bi-directionally with one or more of device 115-a, remote storage 140, and/or remote server 145-a.

The transceiver module 430 may include a modem to modulate the packets and provide the modulated packets to the one or more antennas 435 for transmission, and to demodulate packets received from the one or more antenna 435. While a control panel or a control device (e.g., 205-b) may include a single antenna 435, the control panel or the control device may also have multiple antennas 435 capable of concurrently transmitting or receiving multiple wired and/or wireless transmissions. In some embodiments, one element of apparatus 205-b (e.g., one or more antennas 435, transceiver module 430, etc.) may provide a direct connection to a remote server 145-a via a direct network link to the Internet via a POP (point of presence). In some embodiments, one element of apparatus 205-b (e.g., one or more antennas 435, transceiver module 430, etc.) may provide a connection using wireless techniques, including digital cellular telephone connection, Cellular Digital Packet Data (CDPD) connection, digital satellite data connection, and/or another connection.

The signals associated with system 400 may include wireless communication signals such as radio frequency, electromagnetics, local area network (LAN), wide area network (WAN), virtual private network (VPN), wireless network (using 802.11, for example), 345 MHz, Z-WAVE®, cellular network (using 3G and/or LTE, for example), and/or other signals. The one or more antennas 435 and/or transceiver module 430 may include or be related to, but are not limited to, WWAN (GSM, CDMA, and WCDMA), WLAN (including BLUETOOTH® and Wi-Fi), WMAN (WiMAX), antennas for mobile communications, antennas for Wireless Personal Area Network (WPAN) applications (including RFID and UWB). In some embodiments, each antenna 435 may receive signals or information specific and/or exclusive to itself. In other embodiments, each antenna 435 may receive signals or information not specific or exclusive to itself.

In some embodiments, one or more sensors 150-a (e.g., motion, proximity, smoke, light, glass break, door, camera (image and/or video), window, carbon monoxide, and/or another sensor) may connect to some element of system 400 via a network using one or more wired and/or wireless connections.

In some embodiments, the user interface module 425 may include an audio device, such as an external speaker system, an external display device such as a display screen, and/or an input device (e.g., remote control device interfaced with the user interface module 425 directly and/or through I/O controller module 420).

One or more buses 440 may allow data communication between one or more elements of apparatus 205-b (e.g., processor module 405, memory 410, I/O controller module 420, user interface module 425, etc.).

The memory 410 may include random access memory (RAM), read only memory (ROM), flash RAM, and/or other types. The memory 410 may store computer-readable, computer-executable software/firmware code 415 including instructions that, when executed, cause the processor module 405 to perform various functions described in this disclosure (e.g., identify a unique identifier from a beacon, determine a location of a mobile computing device within a premises, identify user preferences associated with the mobile computing device, and implementing the identified user preferences in relation to an automation system at the premises, etc.). Alternatively, the software/firmware code 415 may not be directly executable by the processor module 405 but may cause a computer (e.g., when compiled and executed) to perform functions described herein. Alternatively, the computer-readable, computer-executable software/firmware code 415 may not be directly executable by the processor module 405 but may be configured to cause a computer (e.g., when compiled and executed) to perform functions described herein.

In some embodiments, the processor module 405 may include, among other things, an intelligent hardware device (e.g., a central processing unit (CPU), a microcontroller, and/or an ASIC, etc.). The memory 410 can contain, among other things, the Basic Input-Output system (BIOS) which may control basic hardware and/or software operation such as the interaction with peripheral components or devices. For example, automation control module 215-b to implement the present systems and methods may be stored within the system memory 410. The apparatus 205-b may include an automation control module 215-b, which may perform the functions described above for the automation control module 215 of apparatus 205 of FIGS. 2 and 3. Applications resident with system 400 are generally stored on and accessed via a non-transitory computer readable medium, such as a hard disk drive or other storage medium. Additionally, applications can be in the form of electronic signals modulated in accordance with the application and data communication technology when accessed via a network interface (e.g., transceiver module 430, one or more antennas 435, etc.).

Many other devices and/or subsystems may be connected to one or may be included as one or more elements of system 400 (e.g., entertainment system, computing device, remote cameras, wireless key fob, wall mounted user interface device, cell radio module, battery, alarm siren, door lock, lighting system, thermostat, home appliance monitor, utility equipment monitor, and so on). In some embodiments, all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and are not discussed in detail in this application. Code to implement the present disclosure can be stored in a non-transitory computer-readable medium such as one or more of system memory 410 or other memory. The operating system provided on I/O controller module 420 may be iOS®, ANDROID®, MS-DOS®, MS-WINDOWS®, OS/2®, UNIX®, LINUX®, or another known operating system.

The transceiver module 430 may include a modem configured to modulate the packets and provide the modulated packets to the antennas 435 for transmission and/or to demodulate packets received from the antennas 435. While the devices 115-a may include a single antenna 435, the devices 115-a may have multiple antennas 435 capable of concurrently transmitting and/or receiving multiple wireless transmissions.

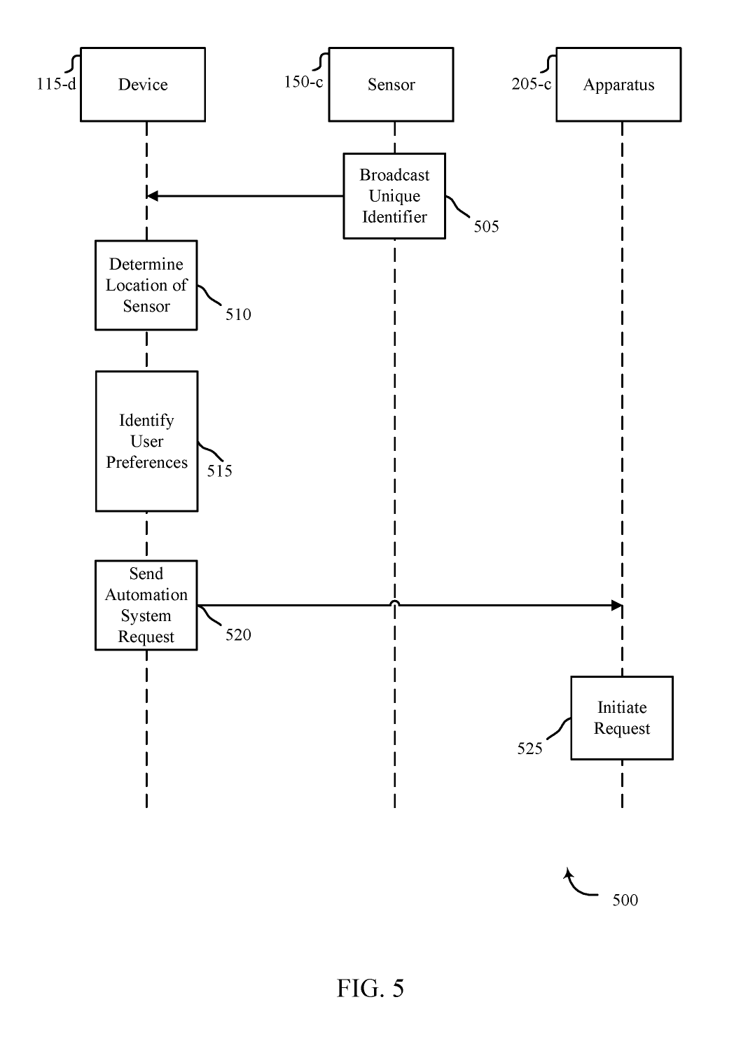

FIG. 5 shows a block diagram of a data flow 500 relating to a security and/or an automation system, in accordance with various aspects of this disclosure. The data flow 500 illustrates the flow of data between a device 115-d, a sensor 150-c, and an apparatus 205-c. The device 115-d may be an example of one or more aspects of a computing device such as a mobile device, laptop, desktop, etc., as illustrated by devices 115 of FIG. 1A and/or devices 115, 120, 130, or 140 of FIG. 1B. Sensor 150-c may be one example of one or more aspects of sensor 150 of FIG. 1A and/or sensor units 150-a, 150-b of FIG. 1B. In some cases, sensor 150-c may include a beacon device. For example, sensor 150-c may include a beacon configured according to the IBEACON® standard set by APPLE®. Apparatus 205-c may be an example of one or more aspects of control panel 105 of FIG. 1A, 135 of FIG. 1B, 205-a of FIG. 3, and/or apparatus 205-b of FIG. 4. In some cases, apparatus 205-c may include a computing device such as a smart phone, desktop, laptop, remote server (e.g., server 155 of FIG. 1B). In some cases, apparatus 205-c may include a storage device and/or database.

At block 505, sensor 150-c may broadcast a unique identifier. Any device within range may receive the broadcast unique identifier. The unique identifier may be a globally unique identifier associated with sensor 150-c. At block 510, device 115-d may receive the broadcasted unique identifier and determine a location of sensor 150-c based on the unique identifier.

For example, device 115-d may store a list of locations associated with one or more sensors of a premises. Additionally, or alternatively, device 115-d may query apparatus 205-c for location information associated with the broadcast unique identifier. In some cases, device 115-d may query the Internet for a location associated with the broadcast unique identifier. For example, device 115-d may query a cloud server to determine the location of the sensor 150-c. Upon receiving the location information, device 115-d may determine its location within the premises.

Additionally, or alternatively, the apparatus 205-c may receive the unique identifier (directly and/or indirectly), query a device for location information and/or determine the location information itself, and/or determine the location of the device 115-d. At block 515 device 115-d may identify user preferences, which may include user preferences for the determined location. For example, a user of device 115-d may specify a temperature of 72 F and a full lighting intensity for the determined location within the premises. In some cases, device 115-d may store the user preferences locally. Additionally, or alternatively, the user preferences may be stored at a control panel, a storage device at the premises, a remote storage device and/or database, in the cloud, etc.

At block 520, upon determining at least one user preference for the determined location, device 115-d may send information, including but not limited to an automation system request, to apparatus 205-c. As one example, apparatus 205-c may include a control panel and/or device 115-d may include a smart phone. Thus, once the smart phone and/or the control panel determines one or more user preferences for the user's and/or the smart phone's determined location, the smart phone may send a request to the control panel to initiate a modification of and/or implement the one or more user preferences.

At block 525, apparatus 205-c may initiate an action related to the request. For example, apparatus 205-c may implement an action in relation to an automation system, apparatus 205-c may send instructions to initiate the action. In one case, the apparatus 205-c may send an instruction to implement the instruction such as a command to adjust lighting, security, HVAC, media parameters, etc. In some embodiments, device receiving the instruction may include and/or execute one or more aspects and/or functions of the apparatus 205-c. Although FIG. 5 depicts device 115-d performing blocks 510-520, in some embodiments one or more aspects of these blocks may be performed by apparatus 205-c and/or sensor 150-c.

Upon detecting a conflict such as a high cost or high energy usage associated with the request, apparatus 205-c may adjust one or more parameters of the request (e.g., selecting a higher or lower target temperature, increasing or decreasing the dimming of lights, etc.). Upon receiving requests from two or more devices, apparatus 205-c may implement individual parts from one or both requests based on which part of the requests costs less, uses less energy, etc. In some cases, apparatus 205-c may determine a priority between two or more users and/or devices and implement multiple requests according to the priority (e.g., a request from a first device supersedes a request from a second device, etc.).

In some embodiments, device 115-d may send the unique identifier to control panel 205-c. Control panel 205-c may determine the location of device 115-d based on the received unique identifier, identify device 115-d (e.g., via unique device identifier, IP address, MAC address, etc.), and/or identify user preferences associating with device 115-d. Control panel 205-c may then implement the identified user preferences for the determined location of device 115-d. For example, control panel 205-c may adjust the heating/cooling and/or lighting of the determined location according to the user preferences. If the determined location is a room with a television, control panel 205-c may turn the television on, activate certain programming, and/or tune to a station designated in the user preferences.

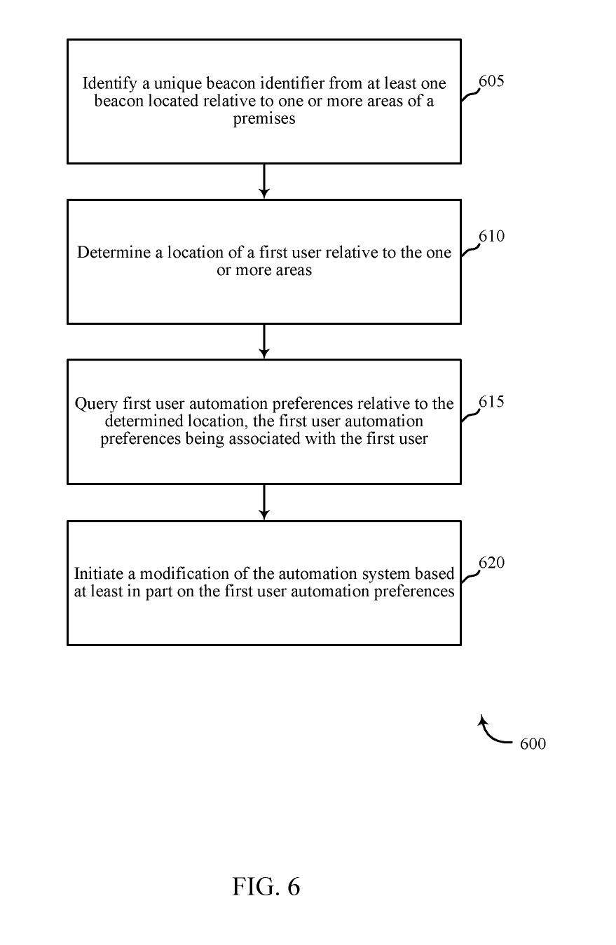

FIG. 6 is a flow chart illustrating an example of a method 600 for security and/or an automation system, in accordance with various aspects of the present disclosure. For clarity, the method 600 is described below with reference to aspects of one or more of the elements and features described with reference to FIGS. 1 and/or 2, and/or aspects of one or more of the elements and features described with reference to FIGS. 3 and/or 4. In some examples, a control panel, backend server, device, and/or sensor may execute one or more sets of codes to control the functional elements of the control panel, backend server, device, and/or sensor to perform the functions described below. Additionally or alternatively, the control panel, backend server, device, and/or sensor may perform one or more of the functions described below using special-purpose hardware. The operation(s) of any one of blocks 605-625 may be performed using the automation control module 215 described with reference to FIGS. 2-4.

At block 605, a unique beacon identifier may be identified from at least one beacon located relative to one or more areas of a premises. At block 610, a location of a first user may be determined relative to the one or more areas. At block 615, first user automation preferences may be queried relative to the determined location. The first user automation preferences may be associated with the first user. For example, the user may be an occupant of the premises. In some cases, the preferences may be associated with a device of the user such as a smart phone. At block 620, a modification of the automation system may be initiated based at least in part on the first user automation preferences.

Thus, the method 600 may provide for identification-based automation control relating to automation/security systems. It should be noted that the method 600 is just one implementation and that the operations of the method 600 may be rearranged or otherwise modified such that other implementations are possible.

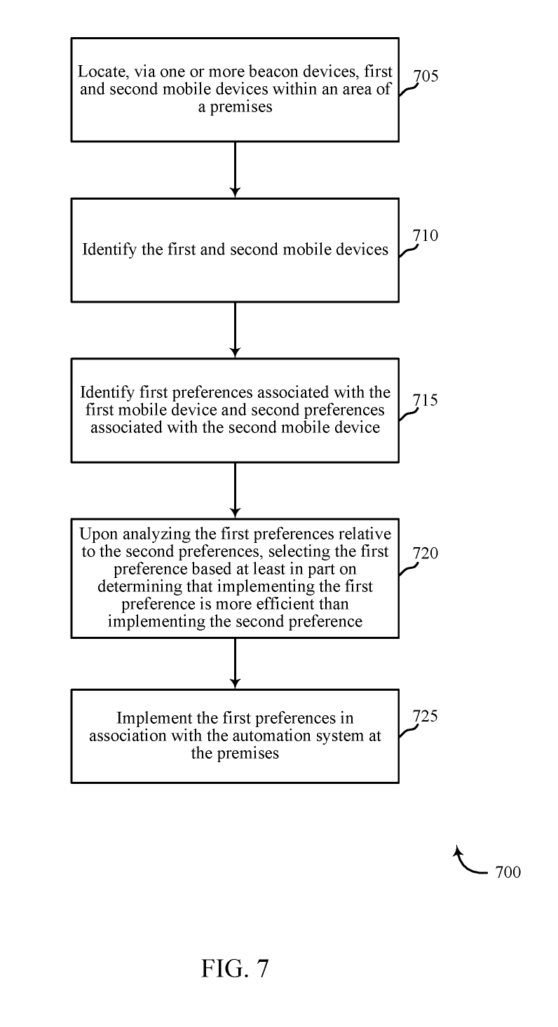

FIG. 7 is a flow chart illustrating an example of a method 700 for security and/or an automation system, in accordance with various aspects of the present disclosure. For clarity, the method 700 is described below with reference to aspects of one or more of the elements and features described with reference to FIGS. 1 and/or 2, and/or aspects of one or more of the elements and features described with reference to FIGS. 3 and/or 4. In some examples, a control panel, backend server, device, and/or sensor may execute one or more sets of codes to control the functional elements of the control panel, backend server, device, and/or sensor to perform the functions described below. Additionally or alternatively, the control panel, backend server, device, and/or sensor may perform one or more of the functions described below using special-purpose hardware. The operation(s) of any one of blocks 705-725 may be performed using the automation control module 215 described with reference to FIGS. 2-4.

At block 705, first and second mobile devices may be located within an area of a premises via one or more beacon devices and the locations of the first and the second mobile devices can be determined. At block 710, the first and second mobile devices may be identified. Identifying a mobile device may include determining an association between the mobile device and an occupant of the premises and/or other information. At block 715, first preferences associated with the first mobile device and second preferences associated with the second mobile device may be identified. The first and second preferences may include one or more preferences associated with settings of an automation system at the premises (e.g., HVAC settings, lighting settings, appliance settings, door lock settings, media settings, etc.). At block 720, upon analyzing the first preferences relative to the second preferences, the first preference may be selected upon determining implementing the first preference is more efficient than implementing the second preference. In some embodiments, determining if a preference is more efficient may include determining that implementing the preference costs less and/or uses less energy than one or more other preferences. At block 725, the first preferences may be implemented in association with the automation system at the premises.

Thus, the method 700 may provide for identification-based automation control relating to automation/security systems. It should be noted that the method 700 is just one implementation and that the operations of the method 700 may be rearranged or otherwise modified such that other implementations are possible.

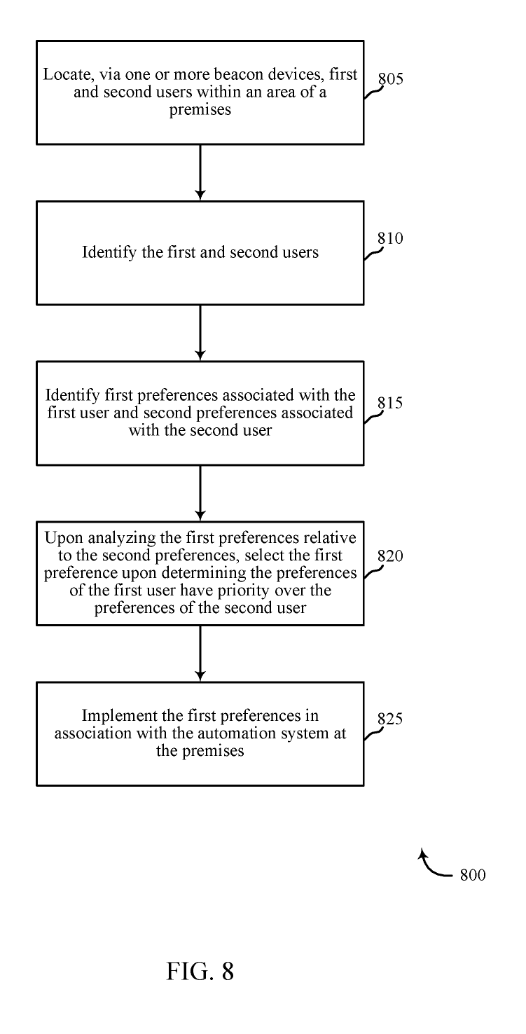

FIG. 8 is a flow chart illustrating an example of a method 800 for security and/or an automation system, in accordance with various aspects of the present disclosure. For clarity, the method 800 is described below with reference to aspects of one or more of the elements and features described with reference to FIGS. 1 and/or 2, and/or aspects of one or more of the elements and features described with reference to FIGS. 3 and/or 4. In some examples, a control panel, backend server, device, and/or sensor may execute one or more sets of codes to control the functional elements of the control panel, backend server, device, and/or sensor to perform the functions described below. Additionally or alternatively, the control panel, backend server, device, and/or sensor may perform one or more of the functions described below using special-purpose hardware. The operation(s) of any one of blocks 805-825 may be performed using the automation control module 215 described with reference to FIGS. 2-4.

At block 805, first and second users may be located within an area of a premises based at least in part on using one or more beacon devices. At block 810, the first and second users may be identified. Identifying a user may include performing facial recognition and/or proximity detection via one or more sensors to identify a user such as an occupant of the premises, a visitor of the premises, an unknown person, etc. At block 815, first preferences associated with the first user and second preferences associated with the second user may be identified. The first and second preferences may include one or more preferences associated with settings of an automation system at the premises (e.g., HVAC settings, lighting settings, appliance settings, door lock settings, media settings, etc.). At block 820, upon analyzing the first preferences relative to the second preferences, the first preference may be selected upon determining the preferences of the first user have priority over the preferences of the second user. For example, a co-worker preference may supersede the preference of another co-worker in the case of an office setting. In the case of a home, a parent preference may supersede a child preference, and a preference of one spouse may supersede the preference of another spouse, etc. At block 825, the first preferences may be implemented in association with the automation system at the premises.

Thus, the method 800 may provide for identification-based automation control relating to automation/security systems. It should be noted that the method 800 is just one implementation and that the operations of the method 800 may be rearranged or otherwise modified such that other implementations are possible.

In some examples, aspects from two or more of the methods 600, 700, and 800 may be combined and/or separated. It should be noted that the methods 600, 700, and 800 are just example implementations, and that the operations of the methods 600, 700, and 800 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

This disclosure may specifically apply to security system applications. This disclosure may specifically apply to automation system applications. In some embodiments, the concepts, the technical descriptions, the features, the methods, the ideas, and/or the descriptions may specifically apply to security and/or automation system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A method for an automation system, comprising:
identifying a unique beacon identifier from at least one beacon located relative to one or more areas of a premises;
determining a location of a first user relative to the one or more areas;
querying first user automation preferences relative to the determined location, the first user automation preferences being associated with the first user; and
initiating a modification of the automation system based at least in part on the first user automation preferences.

2. The method of claim 1, comprising:
determining a temperature of the determined location, wherein the location is determined based on a signal strength between a mobile device and the at least one beacon.

3. The method of claim 1, comprising:
determining a temperature relative to the premises.

4. The method of claim 2, comprising:
analyzing the first user automation preferences relative to the temperature of the determined location.

5. The method of claim 4, comprising:
calculating a first target temperature based at least in part on the analyzing of the first user automation preferences.

6. The method of claim 5, comprising:
modifying the first target temperature based at least in part on determining a temperature relative to the premises.

7. The method of claim 6, comprising:
identifying a second user within a predetermined range of the first user; and
calculating a second target temperature based on second user automation preferences associated with the second user.

8. The method of claim 7, initiating the modification comprising:
transmitting an instruction to implement the first target temperature based at least in part on a determination relating to the first target temperature and the second target temperature.

9. The method of claim 8, comprising:
wherein the determination is based at least in part on a cost.

10. The method of claim 8, comprising:
wherein the determination is based at least in part on a priority setting.

11. The method of claim 10, comprising:
wherein the priority setting specifies that the first user automation preferences supersede the second user automation preferences.

12. The method of claim 1, comprising:
initiating a modification of a climate configuration based at least in part on the determining the location of a first mobile device relative to the one or more areas.

13. An apparatus for an automation system, comprising:
a processor;
memory in electronic communication with the processor; and
instructions stored in the memory, the instructions being executable by the processor to:
identify a unique beacon identifier from at least one beacon located relative to one or more areas of a premises;
determine a location of a first user relative to the one or more areas;
query first user automation preferences relative to the determined location, the first user automation preferences being associated with the first user; and
initiate a modification of the automation system based at least in part on the first user automation preferences.

14. The apparatus of claim 13, the instructions being executable by the processor to:
determine a temperature of the determined location, wherein the location is determined based on a signal strength between a mobile device and the at least one beacon.

15. The apparatus of claim 13, the instructions being executable by the processor to:
determine a temperature relative to the premises.

16. The apparatus of claim 14, the instructions being executable by the processor to:
analyze the first user automation preferences relative to the temperature of the determined location.

17. The apparatus of claim 16, the instructions being executable by the processor to:
calculate a first target temperature based at least in part on the analyzing of the first user automation preferences.

18. The apparatus of claim 17, the instructions being executable by the processor to:
modify the first target temperature based at least in part on determining a temperature relative to the premises.

19. The apparatus of claim 18, the instructions being executable by the processor to:
identify a second user within a predetermined range of the first user; and
calculate a second target temperature based on second user automation preferences associated with the second user.

20. A non-transitory computer-readable medium storing computer-executable code for an automation system, the code executable by a processor to:
identify a unique beacon identifier from at least one beacon located relative to one or more areas of a premises;
determine a location of a first user relative to the one or more areas;
query first user automation preferences relative to the determined location, the first user automation preferences being associated with the first user; and
initiate a modification of the automation system based at least in part on the first user automation preferences.
